(19) United States
(12) Patent Application Publication
(10) Pub. No.: US 2026/0141816 A1
(43) Pub. Date: May 21, 2026

(54) METHOD FOR GENERATING PERSONALIZED LEARNING PATH BASED ON METAHEURISTIC ALGORITHM

(71) Applicant: Zhejiang Normal University, Jinhua (CN)

(72) Inventors: Qionghao HUANG, Jinhua (CN); Feiyang SHU, Jinhua (CN); Can HU, Jinhua (CN); Changqin HUANG, Jinhua (CN); Mengjie YANG, Jinhua (CN); Lingnuo LU, Jinhua (CN)

(73) Assignee: Zhejiang Normal University, Jinhua (CN)

(21) Appl. No.: 19/452,274

(22) Filed: Jan. 17, 2026

(30) Foreign Application Priority Data
Apr. 24, 2025 (CN) 202510520241.7

(51) Int. Cl. G09B 5/00

(52) U.S. Cl. CPC G09B 5/00

(57) ABSTRACT

A method for generating personalized learning path based on a metaheuristic algorithm is disclosed, comprising: initializing a candidate solution population; using a concept coverage function, a time penalty function and a style matching function, constructing a multi-objective fitness function to comprehensively score the candidate solutions; locally updating each candidate solution in the population and updating an expert age, followed by globally updating the candidate solution population by a dynamic control and a migration mechanism. When a set iteration count is reached, calculating and ranking a priority score of the learning material, and generating a personalized learning sequence by utilizing a weighted pooling method. Therefore, by adopting the method for generating a personalized learning path based on a metaheuristic algorithm as described above, issues of local optima and instability can be improved, and more efficient and accurate generation of personalized learning path within the multi-objective optimization can be achieved.

### TECHNICAL FIELD

The present disclosure pertains to the field of personalized learning path generation technology, particularly to a method for generating a personalized learning path based on a metaheuristic algorithm.

### BACKGROUND

With the rapid advancement of online learning and personalized education, designing optimal learning paths tailored to individual students has emerged as a key research focus in the field of education. The generation of the personalized learning paths constitutes a multi-objective optimization problem, constrained by factors including student models, learning material parameters, and knowledge point relationships. Currently, the existing approaches typically employ genetic algorithms, particle swarm optimization, or single biomimetic optimization algorithms to generate personalized learning paths. Nevertheless, when confronted with large-scale learning materials, high-dimensional search spaces, and complex pedagogical constraints, these approaches frequently exhibit diminished optimization efficacy, due to local optima traps, unstable convergence behavior, and insufficient personalized adaptability.

Consequently, a novel optimization method capable of achieving an effective balance between global optimization and local exploration is urgently required. The needed method should be capable of suppressing local optima traps while ensuring the stability of the solution, and should simultaneously accommodate multiple constraints and personalized demands, thereby resolving these technical challenges.

### SUMMARY

An objective of the present disclosure is to provide a method for generating a personalized learning path based on a metaheuristic algorithm. This method overcomes the issue of local optima by leveraging expert-guided memetic mechanism while simultaneously accounting for multi-objective constraint optimization, thereby enhancing convergence stability and computational efficiency.

In order to achieve the above objective, the present disclosure provides a method for generating a personalized learning path based on a metaheuristic algorithm, including the following steps:
S1, based on a student set and a learning material set, generating an initialization candidate solution population through a uniform random distribution, wherein candidate solutions are represented by a decision matrix, and matrix elements identify a selection relationship between students and learning materials;
S2, based on a concept coverage function, a time penalty function and a style matching function, constructing a multi-objective fitness function to comprehensively score the candidate solutions in the population;
S3, based on an expert-guided memetic mechanism, performing an iterative solution by setting an expert age of the candidate solutions, and calculating an expert influence weight by utilizing the expert age, then determining an expert solution based on a probabilistic selection mechanism of the expert influence weight, and locally updating each candidate solution in the population, followed by globally updating the candidate solutions in the population by a dynamic control and a migration mechanism; and
S4, when a set iteration condition is reached, based on the obtained optimal candidate solution, performing a prioritization according to a priority score of the learning material, and generating a personalized learning sequence by utilizing a weighted pooling method.

In some embodiments, the student set is denoted as [symbol] ={S₁, S₂, . . . , Sₙ}, the learning material set is denoted as [symbol] ={M₁, M₂, . . . , Mₘ}, and the decision matrix of candidate solutions is denoted as X=[xᵢⱼ]∈{0,1}^{n×m};
wherein, when the student Sᵢ selects material Mⱼ, xᵢⱼ=1; otherwise, xᵢⱼ=0.
the initialization candidate solution population is denoted as

$$\{ {X}_{1}^{( 0 )} , {X}_{2}^{( 0 )} , … , {X}_{N}^{( 0 )} \}$$

and N denotes a population size.

In some embodiments, in step S2, the expression of the multi-objective fitness function is as follows:

$$F ( X ) = {λ}_{1} {f}_{c o v} ( X ) + {λ}_{2} {f}_{time} ( X ) + {λ}_{3} {f}_{s t y l e} ( X ) ;$$

where F(X) is a multi-objective fitness, f_{cov}(X) is a concept coverage function, fₜᵢₘₑ(X) is a time penalty function, f_{style}(X) is a style matching function, and λ₁, λ₂ and λ₃ are weights of the corresponding functions;
wherein,

$${f}_{c o v} ( X ) = ‖ {C}_{r e q} ∖ {C}_{s e l} ( X ) ‖ + β ‖ {C}_{s e l} ( X ) ∖ {C}_{r e q} ‖ ;$$

$${f}_{time} ( X ) = max \{ 0 , T ( X ) - {T}_{max} \} ;$$

$${f}_{style} ( X ) = {\sum }_{i = 1}^{n} {\sum }_{k = 1}^{4} \vert {S}_{i , k} - {\hat{S}}_{i , k} ( X ) \vert ;$$

where ∥C_{req}\Cₛₑₗ(X)∥ denotes a number of elements of a concept set not covered in the candidate solution, ∥Cₛₑₗ(X)\C_{req}∥ denotes a number of elements of a redundant concept set in the candidate solution, β denotes a redundancy penalty factor, T(X) denotes a cumulative learning time of the learning material selected in the candidate solution, Tₘₐₓ denotes a maximum allowed learning time, S_{i,k} denotes an ideal learning style index of students Sᵢ in k dimensions, and Ŝ_{i,k}(X) denotes an average style index under the candidate solution.

In some embodiments, in step S3, an initial expert age of the candidate solution Xᵢ is set to

$${a}_{i}^{( 0 )} = 0 ,$$

and the expert age is updated after each iteration is completed, as follows:

$${a}_{i}^{( t + 1 )} = {a}_{i}^{( t )} + 1 , ∀ i = 1 , … , N ;$$

where t denotes a current time step, and when the candidate solution Xᵢ is selected as locally optimal or suboptimal, the expert age is set to zero.

In some embodiments, in step S3, according to the expert age, the expert influence weight wᵢ is calculated by using an exponential decay function, as follows:

$${w}_{i} = \{ \begin{matrix}exp ( - θ \cdot {a}_{i}^{( i )} ) , {a}_{i}^{( t )} \leq ω \cdot {T}_{max} \\ 0 , otherwise\end{matrix} ;$$

where θ is an attenuation rate, ω is an allowable age factor, and Tₘₐₓ is a set maximum number of iterations.

In some embodiments, in step S3, for each non-expert solution Xᵢ, a potential expert set Eᵢ={Xⱼ|F(Xⱼ)<F(Xᵢ)} is defined, including candidate solutions with multi-objective fitness is better than that of Xᵢ, and then the expert solution is determined by using the probabilistic selection mechanism based on expert influence weights, as follows:

$$P ( {X}_{j} ) = \frac{{w}_{j}}{{\sum }_{k ∈ {E}_{i}} {w}_{k}} ;$$

where P(Xⱼ) denotes a probability of selecting Xⱼ as the expert solution, wⱼ denotes an expert influence weight corresponding to Xⱼ, and wₖ denotes an expert influence weight corresponding to a k^{th} candidate solution in the expert set Eᵢ;

According to the selection probability of each candidate solution in the expert set Eᵢ, an expert solution Xₖ is selected and the non-expert solution Xᵢ is updated as follows:

$${X}_{i}^{( t + 1 )} = {X}_{i}^{( t )} + r \cdot {w}_{k} \cdot ( {X}_{k} - {X}_{i}^{( t )} ) ;$$

where r is a random disturbance factor.

In some embodiments, in step S3, the candidate solutions in the population are updated by the dynamic control and the migration mechanism, including reflecting a risk degree of the current search by a hazard signal, and the expression is as follows:

$$δ = {( \frac{t}{{T}_{max}} - {r}_{0} )}^{γ} ;$$

where δ is a hazard signal, r₀ is a fixed constant offset, and γ is an adjustment parameter;
when the hazard signal exceeds a predetermined threshold δₜₕ, a migration operation is introduced to update the current candidate solution, as follows:

$${X}_{i}^{( t + 1 )} = {X}_{i}^{( t )} + η \cdot ( {X}_{r a n d 1} - {X}_{r a n d 2} )$$

where η is a migration intensity, and X_{rand 1} and X_{rand 2} are two candidate solutions randomly selected in the population.

In some embodiments, in step S3, the candidate solution in the population is updated by the dynamic control and migration mechanism, including balancing a local development and a global search by a safety signal, as follows:
an expression of the safety signal is:

$$S ( t ) = \frac{1}{1 + {e}^{- κ \cdot ( \frac{t}{{T}_{max}} - θ )}} ;$$

where κ controls steepness of a curve, and θ is a phase shift parameter;
when S(t)≥0.5, the safety signal is dominant, and the population is divided into high-fitness individuals, medium-fitness individuals and offspring individuals, wherein the high-fitness individuals employ a Halton sequence for a global exploration, and the medium-fitness individuals perform the local development around the current optimal solution;
when S(t)<0.5 and δ(t)≥δₜₕ, the hazard signal triggers the migration mechanism;
when S(t)<0.5 and δ(t)<δₜₕ, an integrated optimal solution and a suboptimal solution are updated as follows:

$${X}_{1} = {X}_{best}^{( t )} + {r}_{1} \cdot tan ( {θ}_{1} π ) \cdot \vert {X}_{best}^{( t )} - {X}_{i}^{( t )} \vert ;$$

$${X}_{2} = {X}_{s e c o n d}^{( t )} + {r}_{2} \cdot tan ( {θ}_{2} π ) \cdot \vert {X}_{s e c o n d}^{( t )} - {X}_{i}^{( t )} \vert ;$$

$${X}_{i}^{( t + 1 )} = \frac{{X}_{1} + {X}_{2}}{2} ;$$

where

$${X}_{best}^{( t )}$$

is an optimal candidate solution of a t^{th} iteration,

$${X}_{s e c o n d}^{( t )}$$

is a suboptimal candidate solution of the t^{th} iteration,

$${X}_{i}^{( t + 1 )} and {X}_{i}^{( t )}$$

are candidate solutions of a t+1^{th} iteration and a t^{th} iteration, respectively, r₁, r₂, θ₁ and θ₂ are all random numbers in a range of [0,1], and |⋅| denotes an absolute value operation of an element level.

In some embodiments, in step S4, an expression for the priority score Pⱼ of the learning material is as follows:

$${P}_{j} = α \cdot {I}_{h i g h} ( {M}_{j} ) + β \cdot {I}_{m e d} ( {M}_{j} ) + γ \cdot {I}_{c h} ( {M}_{j} ) ;$$

where I_{high}(⋅), I_{med}(⋅) and I_{ch}(⋅) are the indicator functions that identify a category of learning materials, and α, β and γ are weight coefficients of the corresponding indicator functions.

Therefore, the present disclosure adopts the method for generating a personalized learning path based on a metaheuristic algorithm, and has the following technical effects:

(1) Overcoming the issue of local optima: by employing the expert-guided memetic mechanism, the method continuously stimulates population diversity through the dynamic determination of expert weights and the selection mechanism during the search process, which effectively improves its capability to jump out of local optima.

(2) Enhancing convergence stability and computational efficiency: by introducing dynamic control signals (hazard signals and safety signals) to balance global exploration and local development, which ensures a more stable optimization process and convergence behavior, consequently improving the overall computational efficiency.

(3) Accounting for multi-objective constraint optimization: by designing a three-layer priority mechanism that simultaneously considers factors such as concept coverage, time constraints, and learning style matching within the algorithm, personalized regulation of learning material sorting is achieved, thereby yielding a personalized learning path superior to conventional methods in progressive difficulty, conceptual integrity, and constraint satisfaction.

Further detailed descriptions of the technical scheme of the present disclosure can be found in the accompanying drawings and embodiments.

### BRIEF DESCRIPTION OF THE DRAWINGS

FIG. 1 is a flow chart of a method for generating a personalized learning path based on a metaheuristic algorithm.

### DETAILED DESCRIPTION OF THE EMBODIMENTS

The following embodiments provide a more detailed explanation of the present disclosure. The purpose of disclosing the present disclosure is to protect all variations and improvements within the scope of the present disclosure. It should be understood that the present disclosure is not limited to the embodiments described below.

### Embodiment 1

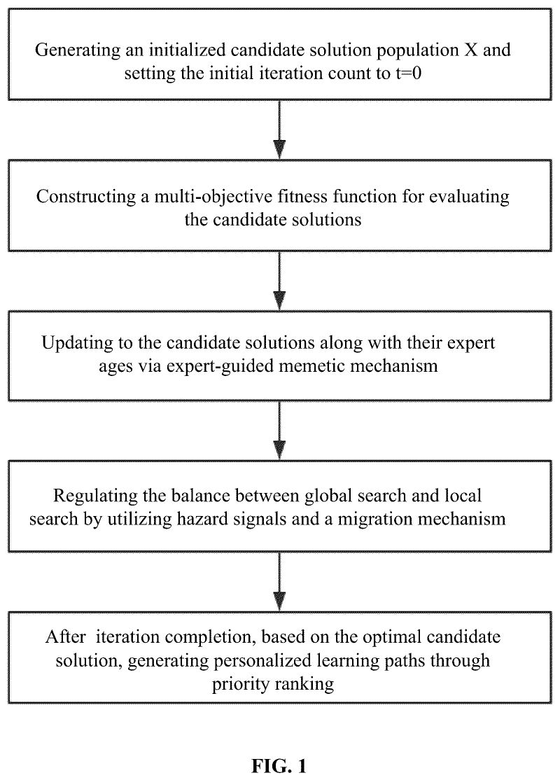

As shown in FIG. 1, the present disclosure provides a method for generating a personalized learning path based on a metaheuristic algorithm. The method primarily involves the initialization of candidate solutions, the construction of the fitness function, updating based on expert guidance, regulation of dynamic control signals, and generation of the final personalized learning path. These steps collectively form a closed-loop dynamic search process, including the following steps:

S1, the student set is defined as [symbol] ={S₁, S₂, . . . , Sₙ}, and the learning material set is defined as [symbol] ={M₁, M₂, . . . , Mₘ}. The candidate solution is represented by a binary decision matrix, as follows:

X=[xᵢⱼ]∈{0,1}^{n×m}, wherein, when the student Sᵢ selects material Mⱼ, xᵢⱼ1; otherwise, xᵢⱼ=0.

The initialization candidate solution population

$$\{ {X}_{1}^{( 0 )} , {X}_{2}^{( 0 )} , … , {X}_{N}^{( 0 )} \}$$

is generated by uniform random distribution, N denotes the population size, and the boundary treatment technique is employed to ensure that each

$${X}_{i}^{( 0 )}$$

is a feasible solution. Additionally, the iterative counter is initialized to t=0, and the maximum number of iterations Tₘₐₓ is specified.

S2, in each iteration, each candidate solution Xᵢ is comprehensively scored. Based on the concept coverage function, time penalty function and style matching function, a multi-objective fitness function F(X) is constructed to provide an evaluation basis for the whole iteration process, as follows:

$$F ( X ) = {λ}_{1} {f}_{c o v} ( X ) + {λ}_{2} {f}_{time} ( X ) + {λ}_{3} {f}_{s t y l e} ( X ) ;$$

wherein,

$${f}_{c o v} ( X ) = ‖ {C}_{r e q} ∖ {C}_{s e l} ( X ) ‖ + β ‖ {C}_{s e l} ( X ) \backslash {C}_{r e q} ‖ ;$$

$${f}_{time} ( X ) = max \{ 0 , T ( X ) - {T}_{max} \}$$

$${f}_{style} ( X ) = {\sum }_{i = 1}^{n} {\sum }_{k = 1}^{4} \vert {S}_{i , k} - {\hat{S}}_{i , k} ( X ) \vert ;$$

where f_{cov}(X) is the concept coverage function, fₜᵢₘₑ(X) is the time penalty function, f_{style}(X) is the style matching function, and λ₁, λ₂ and λ₃ are weights of the corresponding functions; ∥C_{req}\Cₛₑₗ(X)∥ denotes the number of elements of the concept set not covered in the candidate solution, ∥Cₛₑₗ(X)\C_{reg}∥ denotes the number of elements of the redundant concept set in the candidate solution, β denotes the redundancy penalty factor, T(X) denotes the cumulative learning time of the learning material selected in the candidate solution, Tₘₐₓ denotes the maximum allowed learning time, Ŝ_{i,k} denotes the ideal learning style index of students Sᵢ in k dimensions, and Ŝᵢₖ(X) denotes the average style index under the candidate solution. The values of λ₁, λ₂, λ₃, and β are predetermined by problem-specific experts.

S3, in each iteration time step t, the candidate solutions within the population are updated through the expert guidance mechanism. The specific operations are as follows:
the expert age for each candidate solution Xᵢ is set, the initial expert age is

$${a}_{i}^{( 0 )} = 0 ,$$

and the expert age is updated to

$${a}_{i}^{( t + 1 )} = {a}_{i}^{( t )} + 1 ,$$

∀i=1, . . . , N after each iteration is completed. When the candidate solution Xᵢ is selected as locally optimal or suboptimal, that is,

$$F ( {X}_{i}^{( t )} )$$

is the smallest or the second smallest, the expert age is set to zero.

Based on the expert age, the expert influence weight is calculated by using the exponential decay function as follows:

$${w}_{i} = \{ \begin{matrix}exp ( - θ \cdot {a}_{i}^{( t )} ) , {a}_{i}^{( t )} \leq ω \cdot {T}_{max} \\ 0 , otherwise\end{matrix} ;$$

where θ is the attenuation rate, w is the allowable age factor, and Tₘₐₓ is the set maximum number of iterations.

Then, the expert solution is determined based on the probabilistic selection mechanism of expert influence weight. The specific operation is as follows: for each non-expert solution Xᵢ, the potential expert set Eᵢ={Xⱼ|F(Xⱼ)<F(Xᵢ)} is defined, including candidate solutions with multi-objective fitness is better than that of Xᵢ, the probability of selecting X; as the expert solution from the set Et is proportional to the expert influence weight wⱼ is defined, that is, the probability of selecting Xⱼ as the expert solution is

$$P ( {X}_{j} ) = \frac{{w}_{j}}{{\sum }_{k ∈ {E}_{i}} {w}_{k}} ;$$

where wⱼ denotes the expert influence weight corresponding to Xⱼ, and wₖ denotes the expert influence weight corresponding to the k^{th} candidate solution in the expert set Eᵢ. This probabilistic selection mechanism, based on expert influence weights, not only ensures a tendency to learn from high-quality solutions but also prevents premature convergence to a single solution through an age mechanism, thereby effectively maintaining population diversity.

Additionally, in order to balance global search (exploration) and local development (utilization), dynamic control signals are introduced in each iteration, and candidate solutions in the population are updated through dynamic control and migration mechanisms. The specific steps are as follows:
according to the current iteration number t and the maximum iteration number Tₘₐₓ, the hazard signal is defined as:

$$δ = {( \frac{t}{{T}_{max}} - {r}_{0} )}^{γ} ;$$

where δ is the hazard signal, r₀ is the fixed constant offset, and γ is the adjustment parameter.

When the hazard signal exceeds the predetermined threshold δₜₕ, the migration operation is introduced to update the current candidate solution, as follows:

$${X}_{i}^{( t + 1 )} = {X}_{i}^{( t )} + η \cdot ( {X}_{rand 1} - {X}_{rand 2} )$$

where η is the migration intensity, and X_{rand 1} and X_{rand 2} are two candidate solutions randomly selected in the population.

Meanwhile, the safety signal is smoothly adjusted using the Sigmoid function, defined as:

$$S ( t ) = \frac{1}{1 + {e}^{- κ \cdot ( \frac{t}{{T}_{max}} θ )}} ;$$

where κ controls the steepness of the curve, and θ is the phase shift parameter;
when S(t)≥0.5, the safety signal is dominant, and the population is divided into high-fitness individuals, medium-fitness individuals and offspring individuals, wherein the high-fitness individuals employ the Halton sequence for the global exploration, and the medium-fitness individuals perform the local development around the current optimal solution;
when S(t)<0.5 and δ(t)≥δₜₕ, the hazard signal triggers the migration mechanism;
when S(t)<0.5 and δ(t)<δₜₕ, the integrated optimal solution and the suboptimal solution are updated as follows:

$$\begin{matrix}{X}_{1} = {X}_{best}^{( t )} + {r}_{1} \cdot tan ( {θ}_{1} π ) \cdot \vert {X}_{best}^{( t )} - {X}_{i}^{( t )} \vert ; \\ {X}_{2} = {X}_{second}^{( t )} + {r}_{2} \cdot tan ( {θ}_{2} π ) \cdot \vert {X}_{second}^{( t )} - {X}_{i}^{( t )} \vert ; \\ {X}_{i}^{( t + 1 )} = \frac{{X}_{1} + {X}_{2}}{2} ;\end{matrix}$$

where

$${X}_{best}^{( t )}$$

is the optimal candidate solution of the t^{th} iteration,

$${X}_{second}^{( t )}$$

is the suboptimal candidate solution of the t^{th} iteration,

$${X}_{i}^{( t + 1 )} and {X}_{i}^{( t )}$$

are candidate solutions of the t+1^{th} iteration and the t^{th} iteration, respectively, r₁, r₂, θ₁ and θ₂ are all random numbers in the range of [0,1], |⋅| denotes the absolute value operation of an element level.

$${X}_{i}^{( t )}$$

is the matrix, and the update operation is calculated at the element level to ensure that

$${X}_{i}^{( t + 1 )}$$

is still a matrix of n×m.

Local exploitation enables a refined search within identified high-quality regions, improving solution quality and convergence speed, and thereby allowing the learning path to match the requirements of students more precisely. Global exploration is employed to probe unknown solution spaces, preventing fall into local optima and enhancing the algorithm's adaptability to diverse learning requirements. The safety signal mechanism integrates these two search strategies by maintaining a dynamic balance, ensuring that the algorithm not only discovers innovative learning path combinations but also ensures the rationality of these paths in pedagogy.

S4, when the predetermined number of iterations is reached or other termination conditions are satisfied, the iteration is completed.

Wherein, other termination conditions specifically include:

Fitness convergence condition: the fitness threshold change of the optimal candidate solution for k consecutive iterations is less than the predetermined threshold ε, that is,

$$\vert F ( {X}_{best}^{( t )} ) - F ( {X}_{best}^{( t - k )} ) \vert < ε ,$$

where k is the predetermined number of consecutive iterations.

Solution vector convergence condition: the solution vector of the optimal candidate solution changes little after multiple consecutive iterations, that is,

$$‖ {X}_{best}^{( t )} - {X}_{best}^{( t - 1 )} ‖ < {δ}_{0} ,$$

where δ₀ is the distance threshold of the predetermined vector.

Concept coverage completeness condition: the current optimal candidate solution

$${X}_{best}^{( t )}$$

completely covers all the concepts that students need to learn, that is, indicating that all the necessary concepts have been covered.

$$‖ {C}_{req} \backslash {C}_{sel} ( {X}_{best}^{( t )} ) ‖ = 0 ,$$

At this point, the learning materials are graded according to the current optimal candidate solution X*, as follows:

(1) High-priority materials: materials that fully cover the target concepts and satisfy all preliminary knowledge requirements.

(2) Medium-priority materials: materials that partially cover the concepts and match the learning time.

(3) Challenge materials: materials that are moderately more difficult yet still adhere to the specified time limits.

Following this, the priority score of each material is calculated and prioritized. The final personalized learning sequence S is generated via the weighted pooling method. This ensures that the expected objectives in terms of concept coverage, difficulty progression, and time distribution of learning materials are met, thereby addressing the personalized requirements of students. The priority score Pⱼ is defined as:

$${P}_{j} = α \cdot {I}_{high} ( {M}_{j} ) + β \cdot {I}_{med} ( {M}_{j} ) + γ \cdot {I}_{ch} ( {M}_{j} ) ;$$

where I_{high}(⋅), I_{med}(⋅) and I_{ch}(⋅) are the indicator functions that identify the category of learning materials, and α, β and γ are weight coefficients of the corresponding indicator functions.

### Embodiment 2

To verify the technical efficacy of the proposed Memetic Walrus Optimizer (hereinafter referred to as ‘MWO’), which is based on the expert guidance strategy, for the problem of personalized learning path generation, this embodiment evaluates its performance against four existing technologies as comparative embodiments across different problem scales and in terms of learning path generation quality. The compared existing technologies are: the conventional Walrus Algorithm (WO), the Skill Optimization Algorithm (SOA), the Sand Cat Swarm Optimization Algorithm (SCSO), and the Preschool Education Optimization Algorithm (PEOA), specifically including:

(1) Data set and basic configuration: based on the Open University learning dataset (OULAD), a variety of test scenarios containing 100 to 180 learning materials are selected, and the number of student sets and learning material sets is set to 30 and 150-180 respectively, covering a total of 20 knowledge points.

(2) Algorithm parameters: the initial population size is set to 30, and the maximum number of iterations is 500.

(3) Evaluation metrics: this embodiment primarily employs two metrics of the Average Fitness Value (Avg) and the Standard Deviation (Std), to evaluate the algorithm's overall optimization performance. Meanwhile, the quality of the generated personalized learning path is verified using path quality metrics such as concept coverage rate, difficulty progression rate, and difficulty matching rate.

As shown in Table 1, under conditions involving different quantities of learning materials (e.g., 100, 150, and 180), the MWO algorithm achieves the lowest average fitness value. This indicates that the solutions generated by MWO can yield a superior ranking effect while satisfying various educational constraints (such as concept coverage, time limits, and learning style matching). Moreover, the standard deviation of MWO is significantly lower than that of comparable similar algorithms. Notably, in scenarios with 150 learning materials, its standard deviation is merely 18.02, which is significantly lower than other methods. This verifies that the expert guidance and dynamic signal control mechanisms play a significant role in jumping out of local optima and maintaining convergence stability. Additionally, as the number of learning materials increases (from 100 to 180), MWO not only maintains a low fitness value but also exhibits a slight improving trend, further demonstrating its superiority in handling large-scale optimization problems.

TABLE 1
Accuracy of the algorithms for different material quantities

| | Number of Materials | | | | | |
|---|---|---|---|---|---|---|
| Evaluation | 100 | | 150 | | 180 | |
| metric | Avg | Std | Avg | Std | Avg | Std |
| MWO | 600.60 | 27.73 | 598.48 | 18.02 | 593.08 | 19.49 |
| WO | 639.67 | 30.36 | 641.62 | 28.29 | 636.88 | 29.35 |
| SOA | 779.30 | 33.26 | 972.65 | 422.11 | 1085.30 | 493.26 |
| SCSO | 719.58 | 31.81 | 814.85 | 329.43 | 706.30 | 26.22 |
| PEOA | 991.80 | 467.40 | 866.35 | 315.62 | 1271.10 | 696.97 |

On the other hand, in order to intuitively understand the effect of MWO in the process of generating personalized learning paths, a comparative analysis is conducted by randomly selecting the paths of representative students.

TABLE 2
Comparison of recommended paths of learning materials

| | Concept | Difficulty | Difficulty | Difficulty |
|---|---|---|---|---|
| | coverage | progression | matching | matching |
| Algorithm | rate (%) | rate (%) | rate (%) | rate (%) |
| MWO | 100.0 | 90.7 | 100 | 28→90→61→76→35→47→ . . . |
| WO | 100.0 | 83.3 | 96.7 | 28→90→133→76→47→65→ . . . |
| SCSO | 100.0 | 76.3 | 93.3 | 28→2→61→76→47→65→ . . . |
| SOA | 100.0 | 76.7 | 98.2 | 28→76→83→16→80→71→ . . . |
| PEOA | 100.0 | 60.0 | 86.7 | 133→35→47→9→83→110→ . . . |

As shown in Table 2, while all algorithms achieve the required 100% concept coverage, in terms of material sequencing, MWO can rationally allocate key knowledge points and guarantee the coherence of subsequent learning. Furthermore, MWO achieves a difficulty progression rate as high as 90.7% and demonstrates a perfect match with student abilities (100% matching rate). This indicates that MWO outperforms other comparative algorithms in ensuring smooth transitions and hierarchical connections among materials. In contrast, the learning paths generated by prior-art methods such as WO, SOA, SCSO, and PEOA all exhibit a degree of connectivity imbalance.

In summary, the MWO algorithm leverages expert guidance, dynamic hazard-signal control, and multi-layer prioritization mechanism to significantly mitigate the local optima trap and convergence instability in adaptive course scheduling. It simultaneously enables efficient processing of multi-objective constraints. Furthermore, MWO can generate personalized course paths that ensure overall concept coverage while exhibiting smooth difficulty progression and match with student learning capabilities, thereby providing excellent technical and application support for intelligent instruction within the online education domain.

WO is a recently proposed natural heuristic meta-algorithm characterized by its fewer parameters and low computational complexity. Nonetheless, when addressing complex problems containing numerous local optima, it is prone to falling into local optima and exhibits insufficient convergence stability.

SOA is designed for multi-objective optimization problems. While it can simultaneously account for multiple constraints in certain practical applications, its convergence speed is slow in the optimization process, and its global exploration capability within complex search spaces is limited.

SCSO is inspired by swarm intelligence and achieves global search through swarm collaboration. However, its stability and convergence performance remain inadequate for the requirements of personalized learning sequence recommendation when applied to large-scale problems or multi-objective constraint scenarios.

PEOA focuses on optimization within the educational domain, sequencing knowledge points by simulating pedagogical scenarios. Although it yields certain results for specific educational problems, it demonstrates notable shortcomings in algorithmic efficiency and the capacity to solve complex problems.

Therefore, the present disclosure adopts the method for generating a personalized learning path based on a metaheuristic algorithm as described above. This method not only improves the solution to issues of local optima and instability through an overall optimization strategy but also achieves more efficient and accurate generation of personalized learning paths within the multi-objective optimization, thereby providing significant technical and application advantages.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A method for generating a personalized learning path based on a metaheuristic algorithm, comprising the following steps:
S1, based on a student set and a learning material set, generating an initialization candidate solution population through a uniform random distribution, wherein candidate solutions are represented by a decision matrix, and matrix elements identify a selection relationship between students and learning materials;
S2, based on a concept coverage function, a time penalty function and a style matching function, constructing a multi-objective fitness function to comprehensively score the candidate solutions in the population;
S3, based on an expert-guided memetic mechanism, performing an iterative solution by setting an expert age of the candidate solutions, and calculating an expert influence weight by utilizing the expert age, then determining an expert solution based on a probabilistic selection mechanism of the expert influence weight, and locally updating each candidate solution in the population; followed by globally updating the candidate solutions in the population by a dynamic control and a migration mechanism;
calculating a risk degree of the current search by a hazard signal, expressed as follows:
$$δ = {( \frac{c}{{T}_{max}} - {r}_{0} )}^{γ} ;$$
where δ is a hazard signal, r₀ is a fixed constant offset, γ is an adjustment parameter, t denotes a current time step, and Tₘₐₓ is a set maximum number of iterations;
when the hazard signal exceeds a predetermined threshold δₜₕ, introducing a migration operation to update the current candidate solution;
balancing a local development and a global search by a safety signal, as follows:
wherein an expression of the safety signal is:
$$S ( t ) = \frac{1}{1 + {e}^{- κ \cdot ( \frac{t}{{T}_{max}} - θ )}} ;$$
where κ controls a steepness of a curve, and θ is a phase shift parameter;
wherein, when S(t)≥0.5, the safety signal is dominant, and the population is divided into high-fitness individuals, medium-fitness individuals and offspring individuals, wherein the high-fitness individuals employ a Halton sequence for a global exploration, and the medium-fitness individuals perform the local development around the current optimal solution;
wherein, when S(t)<0.5 and δ(t)≥δₜₕ, the hazard signal triggers the migration mechanism;
and wherein, when S(t)<0.5 and δ(t)<δₜₕ, an integrated optimal solution and a suboptimal solution are updated; and
S4, when a set iteration condition is reached, based on the obtained optimal candidate solution, performing a prioritization according to a priority score of the learning material, and generating a personalized learning sequence by utilizing a weighted pooling method.

2. The method for generating a personalized learning path based on a metaheuristic algorithm according to claim 1, wherein the student set is denoted as [symbol] ={S₁, S₂, . . . , Sₙ}, the learning material set is denoted as [symbol] ={M₁, M₂, . . . , Mₘ}, and the decision matrix of candidate solutions is denoted as X=[xᵢⱼ]∈{0,1}^{n×m};
wherein,
$${x}_{i j} = \{ \begin{matrix}1 , & indicating that student {S}_{i} selects material {M}_{j} \\ 0 , & otherwise\end{matrix} ;$$
the initialization candidate solution population is denoted as
$$\{ {X}_{1}^{( 0 )} , {X}_{2}^{( 0 )} , … , {X}_{N}^{( 0 )} \}$$
and N denotes a population size.

3. The method for generating a personalized learning path based on a metaheuristic algorithm according to claim 1, wherein in step S2, the expression of the multi-objective fitness function is as follows:
$$F ( X ) = {λ}_{1} {f}_{c o v} ( X ) + {λ}_{2} {f}_{time} ( X ) + {λ}_{3} {f}_{style} ( X ) ;$$
where F(X) is a multi-objective fitness, f_{cov}(X) is a concept coverage function, fₜᵢₘₑ(X) is a time penalty function, f_{style}(X) is a style matching function, and λ₁, λ₂ and λ₃ are weights of the corresponding functions;
wherein,
$$\begin{matrix}{f}_{c o v} ( X ) = ‖ {C}_{r e q} ∖ {C}_{s e l} ( X ) ‖ + β ‖ {C}_{s e l} ( X ) ∖ {C}_{r e q} ‖ ; \\ {f}_{time} ( X ) = max \{ 0 , T ( X ) - {T}_{max} \} ; \\ {f}_{style} ( X ) = {\sum }_{i = 1}^{n} {\sum }_{k = 1}^{4} \vert {S}_{i , k} - {\hat{S}}_{i , k} ( X ) \vert ;\end{matrix}$$
where ∥C_{req}\Cₛₑₗ(X)∥ denotes a number of elements of a concept set not covered in the candidate solution, λCₛₑₗ(X)\C_{req}∥ denotes a number of elements of a redundant concept set in the candidate solution, β denotes a redundancy penalty factor, T(X) denotes a cumulative learning time of the learning material selected in the candidate solution, Tₘₐₓ denotes a maximum allowed learning time, S_{i,k} denotes an ideal learning style index of students Sᵢ in k dimensions, and Ŝ_{i,k}(X) denotes an average style index under the candidate solution.

4. The method for generating a personalized learning path based on a metaheuristic algorithm according to claim 3, wherein in step S3, an initial expert age of the candidate solution Xᵢ is set to
$${a}_{i}^{( 0 )} = 0 ,$$
and the expert age is updated after each iteration is completed, as follows:
$${a}_{i}^{( t + 1 )} = {a}_{i}^{( t )} + 1 , ∀ i = 1 , … , N ;$$
where t denotes the current time step, and when the candidate solution Xᵢ is selected as locally optimal or suboptimal, the expert age is set to zero.

5. The method for generating a personalized learning path based on a metaheuristic algorithm according to claim 4, wherein in step S3, according to the expert age, the expert influence weight wᵢ is calculated by using an exponential decay function as follows:
$${w}_{i} = \{ \begin{matrix}exp ( - θ \cdot {a}_{i}^{( t )} ) & {a}_{i}^{( t )} \leq ω \cdot {T}_{max} \\ 0 , & otherwise\end{matrix} ;$$
where θ is an attenuation rate, w is an allowable age factor, and Tₘₐₓ is the set maximum number of iterations.

6. The method for generating personalized learning path based on a metaheuristic algorithm according to claim 5, wherein in step S3, for each non-expert solution Xᵢ, a potential expert set Eᵢ={Xⱼ|F(Xⱼ)<F(Xᵢ)} is defined, comprising candidate solutions with multi-objective fitness better than that of Xᵢ, and determining the expert solution by using the probabilistic selection mechanism based on expert influence weights, as follows:
$$P ( {X}_{j} ) = \frac{{w}_{j}}{{Σ}_{k ∈ {E}_{i}} {w}_{k}} ;$$
where P(Xⱼ) denotes a probability of selecting Xⱼ as the expert solution, wⱼ denotes an expert influence weight corresponding to Xⱼ, and wₖ denotes an expert influence weight corresponding to a k^{th} candidate solution in the expert set Eᵢ;
wherein according to the selection probability of each candidate solution in the expert set Eᵢ, an expert solution Xₖ is selected, and the non-expert solution Xᵢ is updated, as follows:
$${X}_{i}^{( t + 1 )} = {X}_{i}^{( t )} + r \cdot {w}_{k} \cdot ( {X}_{k} - {X}_{i}^{( t )} ) ;$$
where r is a random disturbance factor.

7. The method for generating a personalized learning path based on a metaheuristic algorithm according to claim 5, wherein in step S3, the migration operation is introduced to update the current candidate solution, as follows:
$${X}_{i}^{( t + 1 )} = {X}_{i}^{( t )} + η \cdot ( {X}_{rand 1} - {X}_{rand 2} ) ;$$
where η is a migration intensity, and X_{rand 1} and X_{rand 2} are two candidate solutions randomly selected in the population.

8. The method for generating a personalized learning path based on a metaheuristic algorithm according to claim 7, wherein in step S3, the integrated optimal solution and the suboptimal solution are updated, as follows:
$$\begin{matrix}{X}_{1} = {X}_{best}^{( t )} + {r}_{1} \cdot tan ( {θ}_{1} π ) \cdot \vert {X}_{best}^{( t )} - {X}_{i}^{( t )} \vert ; \\ {X}_{2} = {X}_{second}^{( t )} + {r}_{2} \cdot tan ( {θ}_{2} π ) \cdot \vert {X}_{second}^{( t )} - {X}_{i}^{( t )} \vert ; \\ {X}_{i}^{( t + 1 )} = \frac{{X}_{1} + {X}_{2}}{2} ,\end{matrix}$$
where
$${X}_{best}^{( t )}$$
is an optimal candidate solution of a t^{th} iteration,
$${X}_{second}^{( t )}$$
is a suboptimal candidate solution of the t^{th} iteration,
$${X}_{i}^{( t + 1 )} and {X}_{i}^{( t )}$$
are candidate solutions of a t+1^{th} iteration and the t^{th} iteration, respectively, r₁, r₂, θ₁ and θ₂ are all random numbers in a range of [0,1], and |⋅| denotes an absolute value operation of an element level.

9. The method for generating a personalized learning path based on a metaheuristic algorithm according to claim 1, wherein in step S4, an expression for the priority score Pⱼ of the learning material is as follows:
$${P}_{j} = α \cdot {I}_{h i g h} ( {M}_{j} ) + β \cdot {I}_{m e d} ( {M}_{j} ) + γ \cdot {I}_{ch} ( {M}_{j} ) ;$$
where I_{high}(⋅), I_{med}(⋅) and I_{ch}(⋅) are the indicator functions that identify a category of learning materials, and α, β and γ are weight coefficients of the corresponding indicator functions.
